(19) United States
(12) Patent Application Publication
(10) Pub. No.: US 2003/0114020 A1
(43) Pub. Date: Jun. 19, 2003

(54) Electrical connector having top plane

(76) Inventors: Guo Zeng Zhang, Kunsan (CN); GuangXing Shi, Kunsan (CN)

Correspondence Address: Wei Te (Joseph) Chung, Foxconn International, Inc., 1650 Memorex Drive, Santa Clara, CA, 95050, US

(21) Appl. No.: 10/023,620

(22) Filed: Dec. 17, 2001

(51) Int. Cl. H01R 13/60

(52) U.S. Cl. 439/41

(57) ABSTRACT

An electrical connector (1) includes a housing (10) and a shielding (20) receiving the housing therein. The housing includes a body (12) and a flat roof (14) extending from the body. The flat roof has a top plane (18) for being readily attracted by an automatic mechanism during assembling. The shielding defines a cutout (22) receiving a bottom portion of the flat roof.

### BACKGROUND OF THE INVENTION

1. Field of the Invention

The present invention relates to electrical connectors, and particularly to an electrical connector having a top plane.

2. Prior Art

Electrical connectors are required in electronic devices for connection between different electronic devices or components. Mass production is an efficient way to reduce manufacture costs of products and to provide mass products rapidly. Automatic assembling lines are widely used in mass production. Thus, electrical connectors are required to be ready for automatic assembling.

A conventional round Mini Din connector includes a generally cylindrical housing and a shielding surrounding the housing. However, during automatic assembling, the cylindrical housing is unready to be securely seized by automatic mechanism and to be assembled with the shielding properly. This reduces efficiency of the automatic assembling line and adversely increases costs of the electrical connectors.

### SUMMARY OF THE INVENTION

Accordingly, an object of the present invention is to provide an electrical connector having a housing with a top plane for facilitating automatic assembling thereof.

To achieve the above-mentioned object, an electrical connector in accordance with the present invention includes a housing and a shielding receiving the housing therein. The housing includes a body and a flat roof extending from the body. The flat roof has a top plane for being readily attracted by an automatic mechanism during assembling. The shielding defines a cutout receiving a bottom portion of the flat roof.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded view of an electrical connector in accordance with the present invention; and

FIG. 2 is an assembled view of FIG. 1.

### DETAILED DESCRIPTION OF THE PREFERRED EMBODIMENT

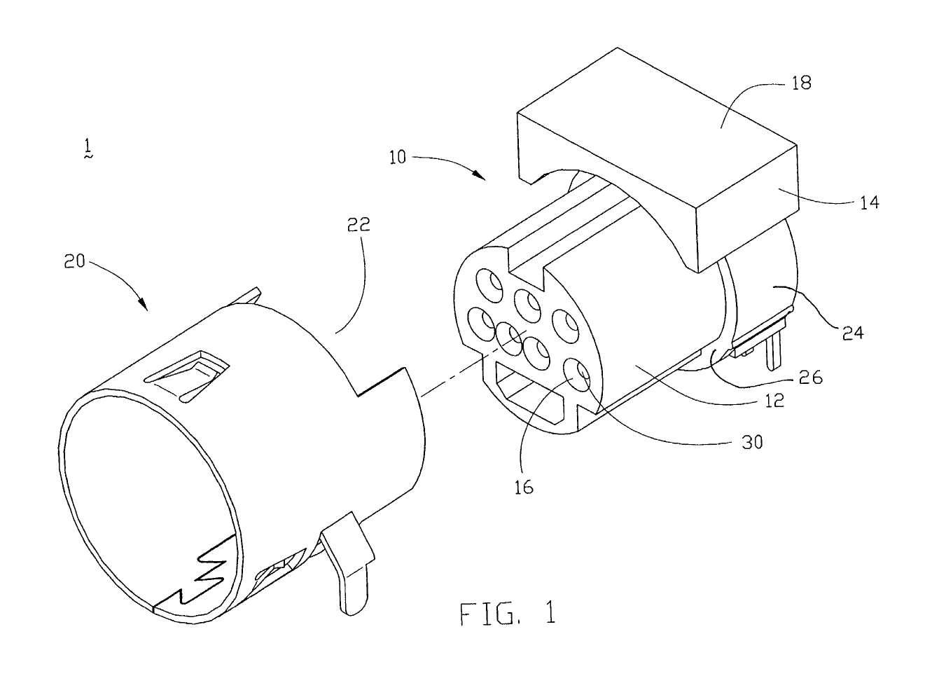

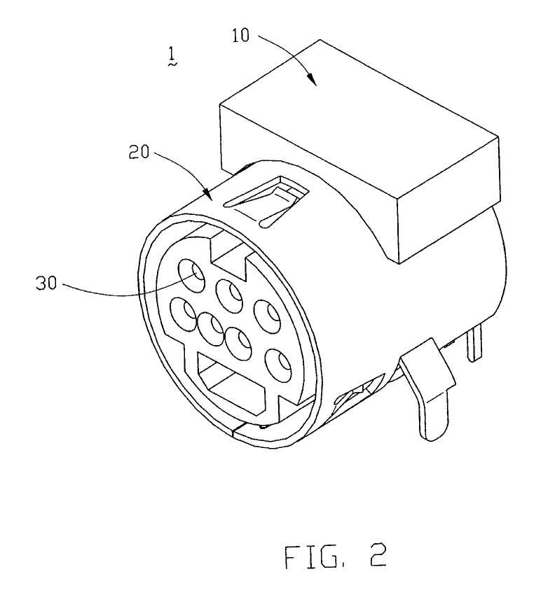

Referring to FIGS. 1 and 2, an electrical connector 1 in accordance with the present invention includes a dielectric housing 10 and a shielding 20 receiving the housing 10 therein.

The housing 10 is integrally made by injection molding and comprises a generally cylindrical body 12 and a flat roof 14 extending from an end portion 24 of the body 12. The end portion 24 of the body 12 is essentially of a larger diameter than the main portion with a step or shoulder 26 therebetween. A plurality of passages 16 is defined in a central portion of the body 12 and along an axial direction of the body 12. A plurality of terminals 30 is received in the passages 16 of the body 12. The flat roof 14 functions as an assembling portion and has a top plane 18. The shielding 20 defines a cutout 22 at an end thereof corresponding to the flat roof 14 of the housing 10.

During automatic assembling, the top plane 18 of the flat roof 14 of the housing 10 is securely attracted by automatic mechanism. The automatic mechanism moves the housing 10 to be received in the shielding 20 with the cutout 22 of the shielding 20 engagingly receiving a bottom portion of the flat roof 14 of the housing 10. Thus, the assembling of the housing 10 and the shielding 20 is readily finished thereby increasing efficiency of assembling process and subsequently reducing costs of the electrical connectors 1. Understandably, end section of the shielding 20 radially abuts against the end portion 24 while leaves a space with regard to the main portion of the body 12 due existence of the step 26 whereby an outer sleeve of the complementary connector is sandwiched between the main portion of the body and the shielding 20 when the complementary connector is mated with the subject connector 1.

More importantly, in assembling the electrical connector 1 to an electronic device (not shown), the electrical connector 1 is readily picked or placed due to the top plane 18 of the flat roof 14 of the housing 10. Thus, efficiency of the assembling process of the electronic device is increased thereby reducing cost of the electronic device.

It is understood that the invention may be embodied in other forms without departing from the spirit thereof. Thus, the present example and embodiment is to be considered in all respects as illustrative and not restrictive, and the invention is not to be limited to the details given herein.

1. An electrical connector comprising:
a housing having a body and an assembling portion extending from the body for being readily picked by an automatic mechanism; and
a shielding receiving the body of the housing therein.

2. The electrical connector as claimed in claim 1, wherein the shielding defines a cutout receiving a portion of the assembling portion.

3. The electrical connector as claimed in claim 1, wherein the assembling portion of the housing is substantially a flat roof.

4. The electrical connector as claimed in claim 3, wherein the flat roof has a plane opposite to the body for being readily attracted by the automatic mechanism.

5. The electrical connector as claimed in claim 1, wherein the body of the housing is substantially cylindrical.

6. The electrical connector as claimed in claim 1, wherein a plurality of passages is defined in a central portion of the body and along an axial direction of the body, and a plurality of terminals is further received in the passages.

7. An electrical connector comprising:
an insulative housing including a cylindrical body with a plurality of terminals therein;
said body defining an radially expanded end portion with a step therebetween;
an assembling portion formed on the end portion with a top plane thereof; and
a tubular metallic shielding coaxially enclosing said body with thereof an end section radially abutting against the end portion.

8. The connector as claimed in claim 7, wherein said top plane extends forwardly beyond said end portion

9. The connector as claimed in claim 7, wherein said shielding defines a cutout located under said assembling portion.

10. The connector as claimed in claim 9, wherein said cutout defines an axial dimension similar to that of the end portion.

11. The connector as claimed in claim 9, wherein said cutout defines a transverse dimension, along a horizontal lateral direction perpendicular to an axial direction of said body, smaller than that of the top plane of said assembling portion.

12. An electrical connector comprising:
an insulative housing defining a cylindrical body;
an assembling portion upwardly formed on a rear end of the body;
a horizontal top plane provide on said assembling portion; and
a tubular metallic shielding enclosing said body with at a rear end thereof a cutout allowing said assembling portion to upwardly extend therebethrough.
